(19) United States
(12) Patent Application Publication
(10) Pub. No.: US 2020/0047535 A1
(43) Pub. Date: Feb. 13, 2020

(54) PRINTABLE FILMS

(71) Applicant: Hewlett-Packard Development Company, L.P., Spring, TX (US)

(72) Inventors: Xiaoqi ZHOU, San Diego, CA (US); Mimi WANG, San Diego, CA (US); Francois K. PIRAYESH, San Diego, CA (US)

(73) Assignee: Hewlett-Packard Development Company, L.P., Spring, TX (US)

(21) Appl. No.: 16/495,859

(22) PCT Filed: Jul. 3, 2017
(86) PCT No.: PCT/US2017/040600

§ 371 Date: Sep. 20, 2019

(51) Int. Cl. B41M 5/52; B32B 33/00; B41M 5/50

(52) U.S. Cl. CPC B41M 5/5254; B41M 5/508; B41M 5/504; B32B 33/00

(57) ABSTRACT

The present disclosure is drawn to printable films. In one example, a printable film can include a transparent polymeric film substrate, an image receiving layer on a front surface of the transparent polymeric film substrate, and a light diffusing layer on a back surface of the transparent polymer film substrate. The image receiving layer can include polymerized vinyl chloride monomer blended with or copolymerized with a second polymerized monomer. The light diffusing layer can include particles of a first inorganic material, particles of a second inorganic material, and a binder.

### BACKGROUND

There are several reasons that inkjet printing has become a popular way of recording images on various media surfaces. Some of these reasons include low printer noise, variable content recording, capability of high speed recording, and multi-color recording. Additionally, these advantages can be obtained at a relatively low price to consumers. Inkjet printing has also been used to print on polymeric media, such as polyvinyl chloride (PVC) media. In such applications of inkjet printing, it can be difficult to achieve high image quality of the printed image at the same time as high durability of the printed image and good flexibility of the polymeric media.

### BRIEF DESCRIPTION OF THE DRAWINGS

FIG. 1 is a cross sectional view of an example printable film in accordance with the present disclosure.

FIG. 2 is a cross sectional view of an example printable film in accordance with the present disclosure.

FIG. 3 is a flow chart of an example method of making a printable film in accordance with the present disclosure.

FIG. 4 is a schematic of an example system including a printable film and an inkjet ink to print onto the printable film in accordance with the present disclosure.

The figures depict several examples of the presently disclosed technology. However, it should be understood that the present technology is not limited to the examples depicted.

### DETAILED DESCRIPTION

The popularity of large format inkjet printing is increasing. Some large format printing applications use a polymeric film as a printing substrate. Examples of such applications include signs, banners, back-lit lighting boxes, illuminated signboards, and others. However, these printing applications often involve several challenges. It can be difficult to achieve sufficient durability of printed images on polymeric media under mechanical actions like rubbing and scratching. In illuminated signboards, a small damage to the media, such as a tiny scratch on the base film or a coating layer on the film, can become very apparent under the illumination of backlights. Similar defect can likewise occur to the printed on a film surface. Printed images made up of a uniform ink film can be easily damaged during handing and installation. Such defects can be especially prominent if the defect is in a dark area of the image, such as high density (percentage) black, cyan, or magenta area fill.

The present disclosure provides printable films with good durability of the printable films and ink films that may be printed thereon The printable films can have strong adhesion between the surface of the printable films and ink films formed thereon. The printed images on the printable films can also have high image quality and good fade resistance.

In some examples of the present disclosure, a printable film can include a transparent polymeric film substrate, an image receiving layer on a front surface of the transparent polymeric film substrate, and a light diffusing layer on a back surface of the transparent polymer film substrate. The image receiving layer can include polymerized vinyl chloride monomer blended with or copolymerized with a second polymerized monomer. For example, the image receiving layer can include a polymer having repeated vinyl chloride units, a blend of such polymer with another polymer, and/or a copolymer formed by copolymerizing vinyl chloride and another monomer. The light diffusing layer can include particles of a first inorganic material, particles of a second inorganic material, and a binder.

In further examples, the second polymerized monomer can be a vinyl monomer, a vinyl ester monomer, a vinyl alcohol monomer, or an acid and anhydride based monomer. In certain examples, the polymerized vinyl chloride monomer can be copolymerized with the second polymerized monomer. In alternative examples, the polymerized vinyl chloride monomer and the second polymerized monomer can be polymerized individually as homopolymers that are blended together. In some examples, the polymerized vinyl monomer can be present in an amount of 15 wt % to 90 wt % by total weight of the image receiving layer.

In further examples, the first inorganic material can have a refractive index greater than 1.8. The second inorganic material can have a refractive index such that a difference between the refractive index of the first inorganic material and the refractive index of the second inorganic material is from 0.4 to 1.8. In still further examples, the particles of the first inorganic material can have a D50 particle size of 400 nm to 700 nm and the particles of the second inorganic material can have a D50 particle size that is 1.5 to 3 times the size of the particles of the first inorganic material. In some examples, the first inorganic material can be titanium dioxide (TiO₂) and the second inorganic material can be calcium carbonate, zeolite, silica, talc, alumina, aluminum trihydrate, calcium silicate, kaolin, calcined clay, or combinations thereof. In another example, the printable film can also include a light blocking layer (opaque) applied to the light diffusing layer opposite the transparent polymeric film substrate.

The present disclosure also extends to methods of making printable films. In some examples, a method of making a printable film can include applying an image receiving layer to a front surface of a transparent polymeric film substrate and applying a light diffusing layer to a back surface of the transparent polymeric film substrate. The image receiving layer can include polymerized vinyl chloride monomer blended with or copolymerized with a second polymerized monomer. The light diffusing layer can include particles of a first inorganic material, particles of a second inorganic material, and a binder.

In a further example, the method can include applying a corona treatment to the transparent polymeric film substrate before applying one or both of the image receiving layer or the light diffusing layer. In another example, the method can include applying a tie layer to the transparent polymeric film substrate before applying one or both of the image receiving layer or the light diffusing layer. The tie layer can include an emulsion of acrylic polymer or acrylic copolymers such as butyl acrylate-ethyl acrylate copolymer having a thickness of 0.1 micrometer to 3 micrometer.

The present disclosure also extends to systems including a printable film and an inkjet ink to print onto the printable film. In some examples, the printable film can include a transparent polymeric film substrate, an image receiving layer on a front surface of the transparent polymeric film substrate, and a light diffusing layer on a back surface of the transparent polymeric film substrate. The image receiving layer can include polymerized vinyl chloride monomer blended with or copolymerized with a second polymerized monomer. The light diffusing layer can include particles of a first inorganic material, particles of a second inorganic material, and a binder. The inkjet ink can include a liquid vehicle, latex particles, and pigment particles.

In some examples, the latex particles can have an average particle size of 20 nm to 500 nm. In further examples, the second polymerized monomer can be a vinyl monomer, a vinyl ester monomer, a vinyl alcohol monomer, or an acid and anhydride based monomer. In still further examples, the polymerized vinyl chloride monomer and the second polymerized monomer can be polymerized together as a copolymer.

It is noted that when discussing the printable films and methods or systems described herein, each of these discussions can be considered applicable to the other examples, whether or not they are explicitly discussed in the context of that example. Thus, for example, in discussing a light diffusing layer related to the printable film, such disclosure is also relevant to and directly supported in the context of the methods and/or systems described herein, and vice versa.

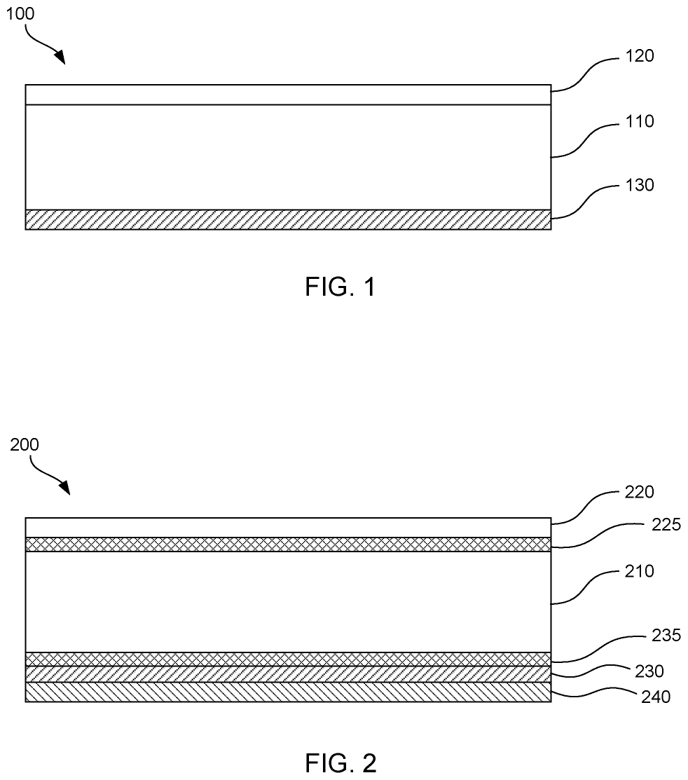

FIG. 1 shows a cross sectional view of an example printable film 100 in accordance with one example of the present disclosure. The printable film can include a transparent polymeric film substrate 110, an image receiving layer 120 on a front surface of the transparent polymeric film substrate, and a light diffusing layer 130 on a back surface of the transparent polymeric film substrate. In some examples, the image receiving layer of the printable film can have strong adhesion to inkjet ink. This can reduce defects in the ink forming the printed image on the printable film. Without being bound to a specific mechanism, the chloride groups present in the image receiving layer may increase the adhesion of the inkjet ink to the image receiving layer. Compared to printing directly on many types of transparent polymeric films, the printable films described herein can have improved ink adhesion. Additionally, in some examples, the printable films can have especially good adhesion when used with latex-based inkjet inks. Thus, latex-based inkjet inks can be printed on the printable films to form durable, scratch resistant images with good image quality. The printed images can also have excellent fade resistance.

As mentioned, in various examples, the printable film can include a transparent polymeric film substrate. When the printable film is used for backlit application such as backlit signboards, the transparent polymeric film substrate can be useful to allow light to shine through the film. When the printable film is front-lit (including a signboard when viewed in daylight), the transparent polymeric film substrate can be useful to allow the light diffusing layer on the back surface of the film to diffuse and reflect light, which can create a uniform, white appearance for the printable film.

The transparent polymeric film substrate can be formed of any transparent polymeric material. As used herein, “transparent” refers to the property of a material that allows sufficient light to pass through the material without being scattered that an image can be clearly seen through the material. In some examples, a transparent material can transmit more than 70% of light passing through the material. In other examples the transparent material can transmit more than 80% or more than 90% of light passing through the material.

In certain examples, the transparent polymeric film substrate can include polyethylene terephthalate. In further examples, the transparent polymeric film can include other polymers such as: polyethylene, including low-density polyethylene, medium-density polyethylene, high-density polyethylene, and linear low-density polyethylene; polypropylene, such as biaxially oriented polypropylene film (BOPP); Nylon; polycarbonate; polyvinyl chloride; polyester; polyamide; bioplastics; biodegradable plastics; or combinations thereof.

The thickness of the transparent polymeric film substrate is not particularly limited. In various examples, the thickness of the transparent polymeric film substrate can be from 100 microns to 500 microns or from 150 microns to 300 microns.

In further examples, the transparent polymeric film substrate can be flexible or rigid. In certain examples, the transparent polymeric film can be in the form of sheets, a roll, or a web of flexible material. In additional examples, the transparent polymeric film substrate can be formed by extrusion.

The transparent polymeric film substrate can, in some examples, be treated before applying the image receiving layer and light diffusing layer. In one example, the transparent polymeric film substrate can be treated with a corona treatment to increase the surface polarity of the film. In another example, the transparent polymeric film substrate can be treated by applying a tie layer. In one such example, the tie layer can include a polymer emulsion. In a specific example, the tie layer can include an emulsion of butyl acrylate-ethyl acrylate copolymer. The tie layer can generally be relatively thin. In some examples, the tie layer can have a thickness from 0.1 micrometer to 1 micrometer or from 0.2 micrometer to 0.5 micrometer.

Turning now to further details regarding the image receiving layer, this layer can be applied to a front surface of the transparent polymeric film substrate. The image receiving layer can include polymers with vinyl chloride repeat units in macromolecular chains. As mentioned above, the chloride groups on the polymers may provide strong adhesion with inkjet ink, and especially latex-based inkjet ink. Additionally, co-solvents in inkjet ink may interact with vinyl chloride polymers. These effects can improve the durability of ink printed on the image receiving layer against mechanical forces such as scratching and rubbing. Unfortunately, polyvinyl chloride homo-polymer itself may not be sufficiently flexible for many applications, and therefore plasticizers such as phthalates have been added to polyvinyl chloride media. These plasticizers can easily migrate out of the polymer matrix, which is disadvantageous because of dropping adhesion between the ink colorant and the print media, and also risk of accumulation of the plasticizers in the environment and the human body.

Accordingly, the image receiving layer according to the present disclosure can include polymerized vinyl chloride monomer blended with or copolymerized with a second polymerized monomer. In some examples, the image receiving layer can include a copolymer of vinyl chloride with a second monomer. As used herein, “copolymer” refers to a polymer formed of more than one type of monomer. Thus, a copolymer can include two different monomers, three different monomers, four different monomers, or any other number of different monomers in any proportion. Accordingly, in some examples, the image receiving layer can include vinyl chloride monomer copolymerized with other monomers to form a copolymer, terpolymer, tetrapolymer, etc.

In other examples, the polymerized vinyl chloride monomer and the second polymerized monomer can be blended. In one such example, the vinyl chloride monomer can be polymerized in the form of a polyvinyl chloride homopolymer. This homopolymer can be blended with a homopolymer of the second monomer. In other examples, the vinyl chloride monomer and/or the second monomer can be copolymerized in separate copolymers, and the copolymers can be blended together. In further examples, the vinyl chloride monomer can be polymerized as a homopolymer and then blended with another copolymer, or the second monomer can be polymerized as a homopolymer and then blended with a copolymer of vinyl chloride.

In various examples, the second polymerized monomer can include vinyl esters such as vinyl acetate, methyl acrylate, ethyl acrylate, 2-ethylhexyl acrylate, 2-hydroxypropyl acrylate, glycidyl acrylate, butoxyethyl acrylate, or combinations thereof. In further examples, the second polymerized monomer can include an acid or an anhydride based monomer such as maleic acid, acrylic acid, fumaric acid, methacrylic acid, maleic anhydride, substituted acrylates, or combinations thereof. Further in another example, the second polymerized monomer can include another vinyl compound such as ethylene, propylene, butene-1, butadiene, isobutylene, ethylenepropylene, styrene, 4-methylpentene, acrylamide, acrylonitrile, methacrylonitrile, butadiene, vinylidene chloride, vinyl butyrate, vinyl butyral, vinyl methyl ketone, acrolein, methacrolein, vinyl ethyl ether, vinyl ethyl sulfone, vinyl pyridine, or combinations thereof. In further examples, the second polymerized monomer can be a copolymer of alkylene oxides such as ethylene oxide or propylene oxide, or arylene oxides such as phenylene oxide, or combinations thereof. The image receiving layer can include polymerized vinyl chloride monomer that is copolymerized with or blended with any of the above monomers.

In further examples, the image receiving layer can include a terpolymer such as vinyl chloride-vinyl acetate-vinyl alcohol terpolymer, vinyl chloride-vinyl acetate-maleic acid terpolymer, styrene-butadiene, ethylene-propylene-dicyclopentadiene terpolymer, butadiene-acrylonitrile-vinyl chloride terpolymers, vinyl chloride-vinylidene chloride-acrylonitrile terpolymers, vinyl chloride-vinyl acetate-maleic anhydride terpolymers, ethylene-propylene-dicyclopentadiene terpolymer, or combinations thereof.

Still further examples of the image receiving layer can include a blend of vinyl chloride homopolymer with another low-Tg polymer such as natural rubber, chlorinated natural rubber, butyl rubber, cis-1,4-polyisoprene, or combinations thereof. As used herein, “low-Tg” refers to polymers have a glass transition temperature of less than 50° C. In other examples, the image receiving layer can include a blend of vinyl chloride homopolymer and: poly(vinyl alkyl ethers) such as poly (vinyl methyl ether), etc.; polyesters such as poly(ethylene terephthalate); polyamides such as nylon, perlon-L, etc.; or combinations thereof. In other examples, the image receiving layer can include poly-(vinylidene chloride), vinylidene chloride-acrylonitrile copolymers, polyvinyl chloride copolymer with poly(ethyl acrylate), poly(ethyl methacrylate), polysulfone, epoxy resins, poly[3,3-bis(chloromethyl)oxtane], polychloroprene, butadiene acrylonitrile copolymers, or combinations thereof. In some examples, commercially available polyvinyl chloride copolymers can be used, such as Kanevinyl™ T5 Series (available from Kaneka Corporation) and those under trade name of VINNOL® resins, such as VINNOL® E/A grades (available from Wacker Chemie AG), which are copolymers and terpolymers of vinyl chloride, hydroxy acrylate and dicarboxylic acid ester.

In various examples, the copolymers and the blends can be used in the form of latex or emulsion made by emulsion polymerization, nano powder as pre-dispersed into an aqueous dispersion using a dispersing agent, and/or present as a solvent based solution using a solvent to pre-dissolve the polymers. Examples of solvents that can be used include, but are not limited to: chlorinated hydrocarbons such as methylene chloride, ethylene chloride, propylene chloride, chloroform, tetrachloromethane, trichloroethylene, and tetrachloroethylene; esters such as methyl acetate, ethyl acetate, propyl acetate, isopropyl acetate, butyl acetate, isobutyl acetate, amyl acetate, 2-methoxyethyl acetate, methoxypropyl acetate, methoxybutyl acetate; butyl hydroxyethanoate; and other solvents that have dissolving capability to dissolve the copolymers. Additional examples of solvents can include dimethyl acetamide, dimethyl formamide, N-methyl-2-pyrrolidone, dimethyl sulfoxide, propylene oxide and pyridine.

There is no specific limitation of the composition of the copolymers. In some examples, the polymerized vinyl chloride monomer can be present in an amount greater than 15% by weight with respect to the dry weight of the image receiving layer. In another example, the polymerized vinyl chloride monomer can be present in an amount greater than 45% by weight or greater than 60% by weight. In yet another example, the polymerized vinyl chloride monomer can be present in an amount less than 90% by weight. In some cases, if the polymerized vinyl chloride monomer is over 90% by weight of the image receiving layer, the image performance in terms of rubbing can be compromised.

In certain examples, the glass transition temperature (Tg) of the polymers and/or copolymers used in the image receiving layer can be controlled to improve performance of the image receiving layer. When the glass transition temperature of the copolymer is high, such as greater than 50° C., then another component can be included as a binder to improve adhesion of the copolymer to the transparent polymer film substrate. This can be useful to achieve high durability performance when an aqueous latex copolymer is used in the image receiving layer. In some such examples, the polymeric binder can be selected from the group of water-soluble binders and water dispersible polymer binders that exhibit high binding power for the transparent polymeric film substrate and the copolymer, either alone or as a combination. In some examples, the polymeric binder components can have a glass transition temperature (Tg) ranging from −30° C. to +50° C. Water dispersible binders can be in the form of emulsion or latex with any backbone structure, such as acrylic polymers or copolymers, vinyl acetate latex, polyesters, vinylidene chloride latex, styrene-butadiene or acrylonitrile-butadiene copolymers. Non-limiting examples of suitable binders can include styrene butadiene copolymer, polyacrylates, polyvinylacetates, polyacrylic acids, polyesters, polyvinyl alcohol, polystyrene, polymethacrylates, polyacrylic esters, polymethacrylic esters, polyurethanes, copolymers thereof, or combinations thereof. In some examples, the binder can be a polymer and/or copolymer selected from the group consisting of acrylic polymers or copolymers, vinyl acetate polymers or copolymers, polyester polymers or copolymers, vinylidene chloride polymers or copolymers, butadiene polymers or copolymers, styrene-butadiene polymers or copolymers, acrylonitrile-butadiene polymers or copolymers, or combinations thereof. In some other examples, the binder component can be a latex containing particles of a vinyl acetate-based polymer, an acrylic polymer, a styrene polymer, an styrene butadiene rubber-based polymer, a polyester-based polymer, a vinyl chloride-based polymer, or the like. In yet some other examples, the binder can be a polymer or a copolymer selected from the group consisting of acrylic polymers, vinyl-acrylic copolymers and acrylic-polyurethane copolymers.

Further, non-limiting examples of water-soluble binders can include poly(ethylene oxide), poly(ethylene oxide-b-propylene oxide), poly(acrylic acid), poly(styrenesulfonic acid), poly(vinyl alcohol), poly(4-vinylpyridine), poly(2-vinylpyridine), poly(N-vinylpyrrolidone), poly(2-ethyl-2-oxazoline), poly(l-glycerol methacrylate), poly(acrylamide, polymethacrylamide, poly(butadiene/maleic acid), poly(allyl amine), poly(N-iso-propylacrylamide), starch derivatives such as dextrin, alkaline-modified starch, oxidized starch, phosphated monostarch, enzyme-treated starch, acetylated starch, hydroxypropylated starch, hydroxyethyl starch with ethylene oxide, cationic starch, or carboxymethylated starch, gelatin, cellulose derivatives such as carboxymethyl ether cellulose, ethyl ether cellulose, ethyl hydroxyethyl ether cellulose, methyl hydroxyethyl ether cellulose and chitosan. Examples of suitable water-dispersible binders can include, but are not limited to, acrylic polymers or copolymers, vinyl acetate latex, polyesters, vinylidene chloride latex, and styrene-butadiene or acrylonitrile-butadiene copolymer latex.

In some examples, the binder can have an average molecular weight (Mw) of about 5,000 to about 500,000. In other examples, the binder can have an average molecular weight (Mw) ranging from about 100,000 to about 300,000. In another example, the binder can have an average molecular weight of about 250,000.

In the case of the solvent based system, the polymeric binder can, in some examples, be selected from the same chemistry family as aqueous binder but the solid state polymeric binder can be pre-dissolved into the solvent descripted above, together with copolymers or mixed into the copolymer solution.

Turning now to the light diffusing layer, in addition to the image receiving layer on the front surface of the transparent polymeric film substrate, the printable films described herein can also include the light diffusing layer applied to the back surface of the transparent polymeric film substrate. The light diffusing layer can uniformly diffuse light shining through the film, such as from back lights in a backlit sign, while allowing the light to pass through the film and illuminate the printed image on the front surface of the film. In some examples, the light diffusing layer can include a composite of at least two kinds of particles and a binder. The particles and binder can scatter light passing through the film. In some examples, the particles and binder can have different refractive indices, which causes light to change direction when passing through these different materials, thus scattering the light. The light diffusing film can scatter light sufficiently that the film can hide any back lights or other objects behind the film, so that the film can have a uniform, white appearance when backlit.

In some examples, the light diffusing layer can include particles of a first inorganic material and particles of a second inorganic material. Using particles with differing refractive indices can help increase light scattering. Therefore, in some examples the first inorganic material can have a refractive index that is higher than the refractive index of the second inorganic material. In a more specific example, the first inorganic material can have a refractive index greater than 1.8. In another example, the first inorganic material can have a refractive index greater than 2.0. In further examples, the second inorganic material can have a lower refractive index such that the difference between the refractive index of the first inorganic material and the second inorganic material is from 0.4 to 1.8. In one example, the first inorganic material can be rutile or anatase titanium dioxide (TiO₂) with refractive index higher than 2.5.

Controlling particle size of the particles in the light diffusing layer can also help improve the light scattering ability of the layer. These particle sizes can thus be defined by the fiftieth-percentile by weight of the particles that are below a given particle size, also referred to herein as D50. In some examples, the particles of the first inorganic material can have a D50 particle size from 400 nm to 700 nm. In further examples, the particles can have a D50 particle size from 500 nm to 600 nm. These particles can effectively scatter visible light having a wavelength from about 400 nm to about 800 nm. In still further examples, the particles of the second inorganic material can be larger to space out the particles of the first inorganic material. In a specific example, the particles of the second inorganic material can have a particle size that is 1.5 to 3 times the size of the particles of the first inorganic material.

There is no specific requirement on chemical composition of the particles of the second inorganic material. In some examples, the particles of the second inorganic material can meet the particle size and refractive index ranges mentioned above. In various examples, the second inorganic material can be calcium carbonate, zeolite, silica, talc, alumina, aluminum trihydrate (ATH), calcium silicate, kaolin, calcined clay, or combinations thereof. In further examples, the particles of the second inorganic material can be present in an amount such that the ratio by weight of the particles of second inorganic material to the particles of the first inorganic material is from 1:15 to 1:300.

The particles of the first and/or second inorganic materials can also be surface modified before mixing into the light diffusing layer coating composition, depending on the particular chemical composition of the particles and the stability requirements of the coating composition. In some examples, surface modification can be accomplished by coupling physically, chemically, or both. In a particular example, the particles can be surface modified by coupling an organosilane compound to the particle surface. The organosilane can be represented by the general formula (RO)₄₋ₓSiY_{X}, where X is from 1 to 3. Each R is individually a hydrocarbyl group containing from 1 to 12 carbon atoms. Each Y is individually an amino group or a hydrocarbyl group containing from 1 to 12 carbon atoms. The RO groups are hydrolysable in a neutral to acidic environment. Non-limiting examples of the organosilane include: a gamma-aminopropyltriethoxy silane, a monoamino silane, a diamino silane, a triamino silane, bis(2-hydroethyl)-3-aminopropyltriethoxysilane, 3-mercaptopropyltrimethoxysilane, 3-glycidoxypropyltrimethoxysilane, bis(triethoxysilylpropyl)disulfide, 3-aminopropyltriethoxysilane, bis-(trimethoxysilylpropyl)amine, N-phenyl-3-aminopropyltrimethoxysilane, N-aminoethyl-3-aminopropylmethyldimethoxysilane, 3-ureidopropyltrimethoxysilane, 3-methacryloxypropyltrimethoxysilane, N-(trimethyloxysilylpropyl)isothiouronium chloride, N-(triethoxysilpropyl)-O-polyethylene oxide, 3-(triethoxylsilyl)propylsuccinic anhydride, 3-(2-imidazolin-1-yl)propyltriethoxysilane, 3-aminopropyltrimethoxysilane, N-(2-aminoethyl-3-aminopropyltrimethoxysilane, 3-(triethoxysilylpropyl)-diethylenetriamine, poly(ethyleneimine)trimethoxysilane, aminoethylaminopropyl trimethoxysilane, aminoethylaminoethylaminopropyl trimethoxysilane, or combinations thereof.

In further examples, a dispersing agent or a combination of several dispersing agents can be used to disperse the particles of the first and second inorganic materials. In some examples, the dispersing agent can include DISPARLON® KS-273N, DISPARLON® KS-873N, DISPARLON® AQ-380 (available from King Industries), DARVAN® 7-N, DARVAN® 670L (available from Vanderbilt Minerals), low molecular weight styrene/maleic anhydride copolymers under the trade name SMA® 1000, SMA® 2000, SMA® 3000 (available from Cray Valley Company), or combinations thereof.

The coating thickness of the light diffusing layer can be controlled to balance the translucence and light diffusion of the film. The optimum coating thickness can depend upon the type and amount ratio of the inorganic particles described above. High opacity of the light diffusing layer can provide good diffusion performance but may decrease media transparence, whereas high transparence may cause non-uniform light distribution. In certain examples, the opacity of the light diffusing layer can be from 60-90 to provide a good balance between light diffusion and translucency. In further examples, the opacity of the light diffusing layer can be from 68 to 82.

In further examples, the printable film can be used in a front-lit application. In such applications, the printable film can include an additional light blocking layer applied over the light diffusing layer. In some examples, the light blocking layer can be opaque and/or can include nano-sized carbon black powder, such as carbon black powder provided by Shanxi Huachang Chemical Co., Ltd, China, or C-E-03-P supplied by American Elements. The light blocking layer can also include a polymeric binder to bind the powder particles to each other and to the surface of the light diffusing layer. In one example, the polymer binder can be a natural polymeric substance, such as gelatin. In other examples, the binder can be any of the polymeric binders described above. In one example, the light blocking layer can use the same polymeric binder as the light diffusing layer.

In further examples, the printable film can include an adhesive layer applied to a back surface of the film. In one example, a printable film for a backlit application can have an adhesive layer applied to the light diffusing layer. In another example, a printable film for a front-lit application can have an adhesive layer applied to the light blocking layer. In an alternative example, FIG. 2 shows a cross sectional view of another printable film 200 in accordance with the present disclosure. The printable film includes a transparent polymeric film substrate 210, an image receiving layer 220 on a front surface of the transparent polymeric film substrate, and a light diffusing layer 230 on a back surface of the transparent polymeric film substrate. This example also includes a front tie layer 225, a back tie layer 235, and a light blocking layer 240. The tie layers (front and/or back) can be of any material that ties the respective layers together, but in certain examples, they can include an emulsion of butyl acrylate-ethyl acrylate copolymer having a thickness of 0.1 micrometer to 1 micrometer. In another example, the tie layer(s) can have a thickness of 0.2 micrometer to 0.5 micrometer. The light blocking layer can be of any material to provides non-transference (or minimal transference to effectively appear opaque) of light through the layer.

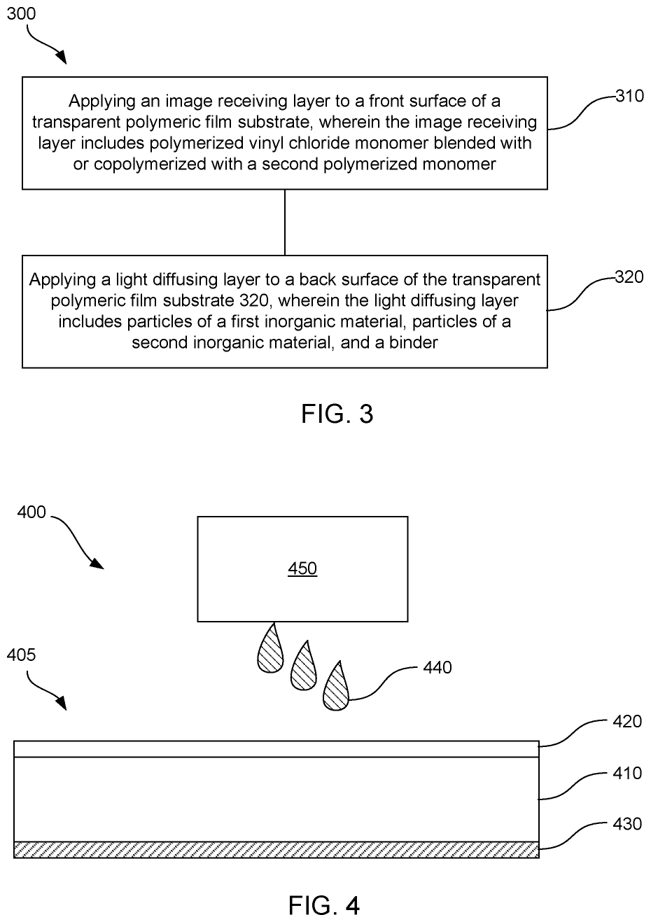

The present disclosure also extends to methods of making printable films. FIG. 3 is a flow chart of an example method 300 of making a printable film. The method includes applying 310 an image receiving layer to a front surface of a transparent polymeric film substrate, wherein the image receiving layer includes polymerized vinyl chloride monomer blended with or copolymerized with a second polymerized monomer, and applying 320 a light diffusing layer to a back surface of the transparent polymeric film substrate, wherein the light diffusing layer includes particles of a first inorganic material, particles of a second inorganic material, and a binder.

In further examples, the method can include treating the transparent polymeric film substrate before applying one or both of the image receiving layer and the light diffusing layer. In one example, the transparent polymeric film substrate can be treated with a corona treatment to increase adhesion of the layers applied to the substrate. In another example, a tie layer can be applied to the transparent polymeric film substrate. The tie layer can include an emulsion of butyl acrylate-ethyl acrylate copolymer having a thickness of 0.1 micrometer to 1 micrometer. In another example, the tie layer can have a thickness of 0.2 micrometer to 0.5 micrometer.

The present disclosure also extends to systems that include a printable film and an inkjet ink to print onto the printable film. FIG. 4 shows a schematic of an example system 400 including a printable film 405 and an inkjet ink 440 to print onto the printable film. In this particular example, the inkjet ink is loaded into an inkjet printer 450 to print the ink onto the printable film. As in other examples described herein, the printable film includes a transparent polymeric film substrate 410, an image receiving layer 420 on a front surface of the transparent polymeric film substrate, and a light diffusing layer 430 on a back surface of the transparent polymeric film substrate. The image receiving layer can include polymerized vinyl chloride monomer blended with or copolymerized with a second polymerized monomer. The light diffusing layer can include particles of a first inorganic material, particles of a second inorganic material, and a binder. The inkjet ink can include a liquid vehicle, latex particles, and pigment particles.

In some examples, the inkjet ink can be a latex-based ink composition. Thus, the ink can include a polymeric latex. In some examples, the polymeric latex can be suspended in an ink vehicle. In one example, the polymeric latex can be a preparation of a stable dispersion of polymeric micro-particles dispersed in the ink vehicle. In further examples, the polymeric latex can be natural latex or synthetic latex. Synthetic latexes can be produced by emulsion polymerization using a variety of initiators, surfactants and monomers. In some examples, the polymeric latex can be cationic, anionic, or amphoteric polymeric latex. A variety of latex polymers can be used in the inks described herein including self-dispersed and functionalized latex polymers. In various examples, the latex can include polymerized monomers such as ethyl acrylate; ethyl methacrylate; benzyl acrylate; benzyl methacrylate; propyl acrylate; propyl methacrylate; iso-propyl acrylate; iso-propyl methacrylate; butyl acrylate; butyl methacrylate; hexyl acrylate; hexyl methacrylate; octadecyl methacrylate; octadecyl acrylate; lauryl methacrylate; lauryl acrylate; hydroxyethyl acrylate; hydroxyethyl methacrylate; hydroxyhexyl acrylate; hydroxyhexyl methacrylate; hydroxyoctadecyl acrylate; hydroxyoctadecyl methacrylate; hydroxylauryl methacrylate; hydroxylauryl acrylate; phenethyl acrylate; phenethyl methacrylate; 6-phenylhexyl acrylate; 6-phenylhexyl methacrylate; phenyllauryl acrylate; phenyllauryl methacrylate; 3-nitrophenyl-6-hexyl methacrylate; 3-nitrophenyl-18-octadecyl acrylate; ethyleneglycol dicyclopentyl ether acrylate; vinyl ethyl ketone; vinyl propyl ketone; vinyl hexyl ketone; vinyl octyl ketone; vinyl butyl ketone; cyclohexyl acrylate; methoxysilane; acryloxypropyhiethyldimethoxysilane; trifluoromethyl styrene; trifluoromethyl acrylate; trifluoromethyl methacrylate; tetrafluoropropyl acrylate; tetrafluoropropyl methacrylate; heptafluorobutyl methacrylate; iso-butyl acrylate; iso-butyl methacrylate; 2-ethylhexyl acrylate; 2-ethylhexyl methacrylate; iso-octyl acrylate; iso-octyl methacrylate; or combinations thereof.

In some examples, the latex can have a weight average molecular weight ranging from about 10,000 Mw to about 5,000,000 Mw. In other examples, the polymeric latex particulates have a weight average molecular weight ranging from about 40,000 Mw to about 100,000 Mw. In certain examples, the polymeric latex can include acrylic polymers or copolymers, vinyl acetate polymers or copolymers, polyester polymers or copolymers, vinylidene chloride polymers or copolymers, butadiene polymers or copolymers, styrene-butadiene polymers or copolymers, acrylonitrile-butadiene polymers or copolymers, or combinations thereof. In further examples, the polymeric latex can include latex particulates having a size ranging from about 20 nm to about 500 nm. In some other examples, the polymeric latex particulates can have a size ranging from about 100 nm to about 300 nm.

In further examples, the ink composition can include polymeric latex particulates in an amount representing from about 0.5% to about 15% by weight based on the total weight of the ink composition. In some examples, the polymeric latex particulates can be made up of a plurality of monomers that are randomly polymerized and that can be crosslinked. When crosslinked, the molecular weight can be even higher than the molecular weights described above. Examples of polymeric latex particulates that can be used include those prepared using a mix of monomers having various weight ratios. Examples of such monomers can include styrene, hexyl methacrylate, ethylene glycol dimethacrylate and methacrylic acid. All these monomers can be copolymerized to form the latex. In some examples, the polymeric latex particulates can include styrene and hexyl methacrylate monomers that can provide the bulk of the latex particulate, and ethylene glycol dimethacrylate and methyl methacrylate that can be copolymerized therewith in smaller amounts. Other combinations of monomers can similarly be used to form latex particulates. Additional non-limiting examples of monomers that can be used to form the latex particulates include styrenes, C1 to C8 alkyl methacrylates, C1 to C8 alkyl acrylates, ethylene glycol methacrylates and dimethacrylates, methacrylic acids, acrylic acids, and the like.

In some examples, the latex particulates can have a glass transition temperature (Tg) of 90° C. or greater.

In further examples, the inkjet ink can include colorants that impart the desired color to the printed image. As used herein, “colorant” includes dyes, pigments, and/or other particulates that may be suspended or dissolved in an ink vehicle. The colorant can be present in the ink composition in an amount required to produce the desired contrast and readability. In some examples, the colorant can be present in an amount from 0.5 wt % to 10 wt % in the ink. In one example, the colorant can be present in an amount from 1 wt % to 5 wt %. In another example, the colorant can be present in an amount from 5 wt % to 10 wt %. In some other examples, the ink composition can include pigments as colorants.

Pigments that can be used include self-dispersed pigments and non self-dispersed pigments. The pigment can be self-dispersed with a polymer, oligomer, or small molecule; or can be dispersed with a separate dispersant. Non-limiting examples of suitable pigments can include black pigments, white pigments, cyan pigments, magenta pigments, yellow pigments, or the like. Suitable pigments include, but are not limited to, the following pigments available from BASF: Paliogen®) Orange, Heliogen® Blue L 6901F, Heliogen®) Blue NBD 7010, Heliogen® Blue K 7090, Heliogen® Blue L 7101F, Paliogen®) Blue L 6470, Heliogen®) Green K 8683, and Heliogen® Green L 9140. The following black pigments are available from Cabot: Monarch® 1400, Monarch® 1300, Monarch®) 1100, Monarch® 1000, Monarch®) 900, Monarch® 880, Monarch® 800, and Monarch®) 700. The following pigments are available from CIBA: Chromophtal®) Yellow 3G, Chromophtal®) Yellow GR, Chromophtal®) Yellow 8G, Igrazin® Yellow 5GT, Igrante® Rubine 4BL, Monastral® Magenta, Monastral® Scarlet, Monastral® Violet R, Monastral® Red B, and Monastral® Violet Maroon B. The following pigments are available from Degussa: Printex® U, Printex® V, Printex® 140U, Printex® 140V, Color Black FW 200, Color Black FW 2, Color Black FW 2V, Color Black FW 1, Color Black FW 18, Color Black S 160, Color Black S 170, Special Black 6, Special Black 5, Special Black 4A, and Special Black 4. The following pigment is available from DuPont: Tipure®) R-101. The following pigments are available from Heubach: Dalamer® Yellow YT-858-D and Heucophthal Blue G XBT-583D. The following pigments are available from Clariant: Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, Novoperm® Yellow HR, Novoperm® Yellow FGL, Hansa Brilliant Yellow 10GX, Permanent Yellow G3R-01, Hostaperm® Yellow H4G, Hostaperm® Yellow H3G, Hostaperm® Orange GR, Hostaperm® Scarlet GO, and Permanent Rubine F6B. The following pigments are available from Mobay: Quindo® Magenta, Indofast® Brilliant Scarlet, Quindo® Red R6700, Quindo® Red R6713, and Indofast® Violet. The following pigments are available from Sun Chemical: L74-1357 Yellow, L75-1331 Yellow, and L75-2577 Yellow. The following pigments are available from Columbian: Raven® 7000, Raven® 5750, Raven® 5250, Raven® 5000, and Raven® 3500. The following pigment is available from Sun Chemical: LHD9303 Black.

In other examples, the colorant can be a dye. The dye may be nonionic, cationic, anionic, or a mixture of nonionic, cationic, and/or anionic dyes. Specific examples of dyes that may be used include, but are not limited to, Sulforhodamine B, Acid Blue 113, Acid Blue 29, Acid Red 4, Rose Bengal, Acid Yellow 17, Acid Yellow 29, Acid Yellow 42, Acridine Yellow G, Acid Yellow 23, Acid Blue 9, Nitro Blue Tetrazolium Chloride Monohydrate or Nitro BT, Rhodamine 6G, Rhodamine 123, Rhodamine B, Rhodamine B Isocyanate, Safranine O, Azure B, and Azure B Eosinate, which are available from Sigma-Aldrich Chemical Company (St. Louis, Mo.). Examples of anionic, water-soluble dyes include, but are not limited to, Direct Yellow 132, Direct Blue 199, Magenta 377 (available from Ilford AG, Switzerland), alone or together with Acid Red 52. Examples of water-insoluble dyes include azo, xanthene, methine, polymethine, and anthraquinone dyes. Specific examples of water-insoluble dyes include Orasol® Blue GN, Orasol® Pink, and Orasol® Yellow dyes available from Ciba-Geigy Corp. Black dyes may include, but are not limited to, Direct Black 154, Direct Black 168, Fast Black 2, Direct Black 171, Direct Black 19, Acid Black 1, Acid Black 191, Mobay Black SP, and Acid Black 2.

As used herein, “liquid vehicle” is defined to include any liquid composition that is used to carry colorants, including pigments or dyes, to a substrate. A wide variety of liquid vehicle components may be used and include, as examples, water or any kind of solvents. Such liquid vehicles may further include a mixture of different agents, including without limitation, surfactants, solvents and co-solvents, buffers, biocides, viscosity modifiers, sequestering agents, stabilizing agents and water. Though not liquid per se, the liquid vehicle can also carry other solids, such as polymers, UV curable materials, plasticizers, salts, etc. In some examples, the liquid vehicle formulation can include water and a co-solvent or co-solvents present in total at from 1 wt % to 50 wt %, depending on the jetting architecture. Further, a non-ionic, cationic, and/or anionic surfactant can optionally be present, ranging from 0.01 wt % to 20 wt %. In one example, the surfactant can be present in an amount from 5 wt % to 20 wt %. The liquid vehicle can also include dispersants in an amount from 5 wt % to 20 wt %. The balance of the formulation can be purified water, or other vehicle components such as biocides, viscosity modifiers, materials for pH adjustment, sequestering agents, preservatives, and the like. In one example, the liquid vehicle can be predominantly water.

Classes of co-solvents that can be used can include organic co-solvents including aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of solvents that can be used include, but are not limited to, 2-pyrrolidinone, N-methylpyrrolidone, 2-hydroxyethyl-2-pyrrolidone, 2-methyl-1,3-propanediol, tetraethylene glycol, 1,6-hexanediol, 1,5-hexanediol and 1,5-pentanediol.

A surfactant or surfactants can also be included, such as alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like. The amount of surfactant added to the formulation of this disclosure may range from 0.01 wt % to 20 wt %. Suitable surfactants can include, but are not limited to, liponic esters such as Tergitol™ 15-S-12, Tergitol™ 15-S-7 available from Dow Chemical Company, LEG-1 and LEG-7; Triton™ X-100; Triton™ X-405 available from Dow Chemical Company and sodium dodecylsulfate.

Consistent with the formulation of this disclosure, various other additives can be employed to optimize the properties of the fluids for specific applications. Examples of these additives are those added to inhibit the growth of harmful microorganisms. These additives may be biocides, fungicides, and other microbial agents. Examples of suitable microbial agents include, but are not limited to, Nuosept® (Nudex, Inc.), Ucarcide™ (Union carbide Corp.), Vancide® (R.T. Vanderbilt Co.), Proxel® (ICI America), and combinations thereof.

Sequestering agents, such as EDTA (ethylene diamine tetra acetic acid), may be included to eliminate the deleterious effects of heavy metal impurities, and buffer solutions may be used to control the pH of the fluids. From 0.01 wt % to 2 wt %, for example, can be used. Viscosity modifiers and buffers may also be present, as well as other additives to modify properties of the fluids as desired. Such additives can be present at from 0.01 wt % to 20 wt %.

It is noted that, as used in this specification and the appended claims, the singular forms “a,” “an,” and “the” include plural referents unless the context clearly dictates otherwise.

As used herein, “liquid vehicle” or “ink vehicle” refers to a liquid fluid in which additives are placed to form jettable fluids, such as inks. A wide variety of liquid vehicles may be used in accordance with the technology of the present disclosure. Such liquid or ink vehicles may include a mixture of a variety of different agents, including, surfactants, solvents, co-solvents, anti-kogation agents, buffers, biocides, sequestering agents, viscosity modifiers, surface-active agents, water, etc. Though not part of the liquid vehicle per se, in addition to the colorants, the liquid vehicle can carry solid additives such as polymers, latexes, UV curable materials, plasticizers, salts, etc.

As used herein, “soluble,” refers to a solubility percentage of more than 5 wt %.

As used herein, “ink jetting” or “jetting” refers to compositions that are ejected from jetting architecture, such as ink-jet architecture. Ink-jet architecture can include thermal or piezo architecture. Additionally, such architecture can be configured to print varying drop sizes such as less than 10 picoliters, less than 20 picoliters, less than 30 picoliters, less than 40 picoliters, less than 50 picoliters, etc.

As used herein, the term “substantial” or “substantially” when used in reference to a quantity or amount of a material, or a specific characteristic thereof, refers to an amount that is sufficient to provide an effect that the material or characteristic was intended to provide. The exact degree of deviation allowable may in some cases depend on the specific context.

As used herein, the term “about” is used to provide flexibility to a numerical range endpoint by providing that a given value may be “a little above” or “a little below” the endpoint. The degree of flexibility of this term can be dictated by the particular variable and determined based on the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include the numerical values explicitly recited as the limits of the range and individual numerical values or sub-ranges encompassed within that range as if each numerical value and sub-range is explicitly recited. As an illustration, a numerical range of “about 1 wt % to about 5 wt %” should be interpreted to include the explicitly recited values of about 1 wt % to about 5 wt % and individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

### EXAMPLES

The following illustrates examples of the present disclosure. However, it is to be understood that the following are merely illustrative of the application of the principles of the present disclosure. Numerous modifications and alternative compositions, methods, and systems may be devised without departing from the spirit and scope of the present disclosure. The appended claims are intended to cover such modifications and arrangements.

### Example 1

A series of PET film substrates were subjected to corona treatment and a tie layer of 0.2 micrometer to 0.5 micrometer thickness of a copolymer emulsion of butyl acrylate-ethyl acrylate copolymer was applied. An image receiving layer was applied to each film substrate. The image receiving layers for each of the films had the compositions shown in Table 1. The cells of Table 1 show the amount in parts by weight of each ingredient in example image receiving layers IR1 through IR4.

TABLE 1

| | IR1 | IR2 | IR3 | IR4 |
|---|---|---|---|---|
| | (Parts by | (Parts by | (Parts by | (Parts by |
| Component | Dry Weight) | Dry Weight) | Dry Weight) | Dry Weight) |
| Vinyl chloride/ | 100 | 100 | — | — |
| vinyl acetate/ | | | | |
| maleic acid | | | | |
| terpolymers | | | | |
| Vinnol E15/45 | — | — | 100 | — |
| MTF | | | | |
| Vinyl chloride/ | — | — | — | 100 |
| vinyl acetate/ | | | | |
| maleic acid | | | | |
| copolymers | | | | |
| Tetrahydrofuan | Sufficient | Sufficient | Sufficient | Sufficient |
| (solvent) | amount to | amount to | amount to | amount to |
| | fully | fully | fully | fully |
| | dissolve | dissolve | dissolve | dissolve |
| | polymer | polymer | polymer | polymer |
| Aradur ® 2594 | — | 10 | 10 | — |
| Araldite ® | — | 10 | 10 | — |
| GY285 | | | | |
| BYK | 1 | 1 | 1 | 1 |
| Dynwet ® | | | | |
| 800 | | | | |
| 2-Butanone | Sufficient | Sufficient | Sufficient | Sufficient |
| (MEK) | amount to | amount to | amount to | amount to |
| cosolvent | achieve | achieve | achieve | achieve |
| | desired | desired | desired | desired |
| | viscosity | viscosity | viscosity | viscosity |

Aradur ® 2594 and Araldite ® GY285 (Huntsman Advanced Materials, Salt Lake City, USA); and BYK Dynwet ® 800 (Byk Additives and Instruments, Germany).

A light diffusing layer was applied to the back of each film substrate. The light diffusing layer had the composition shown in Table 2. The inorganic particles were pre-treated using gamma-aminopropyltriethoxy silane.

TABLE 2

| Component | Parts by Dry Weight |
|---|---|
| Titanium dioxide | 95 |
| Calcium carbonate | 5 |
| Binder | 18 |
| Defoamer | 1 |
| Surfactant | 0.5 |
| Dye 1 | 0.007 |
| Dye 2 | 0.003 |

The substrates were tested for image quality, coin scratch test, Taber abrasion, and light block effect. The results of the tests are shown in Tables 3 and 4. Image quality was scored based on a combination of color gamut and bleed. The gamut was evaluated by using a Barbieri Spectro® LFP spectrophotometer in transmissive mode to measure L* a* b* values of 72 patches of solid color. The bleed was evaluated visually on a specific image created to evaluate bleed. The Taber durability was evaluated using a Taber® Linear Abraser tool with a crocking kit. The coin scratch durability was evaluated using the Taber® Linear Abraser tool with a 75 degree coin holder attachment to hold a copper coin. The angle and the hardness of the copper coin were made to specifically mimic a human nail scratch.

TABLE 3

| | | Image | Light | Light |
|---|---|---|---|---|
| Sample ID | Base | receiving layer | diffusion layer | block layer |
| Exp. 1 | PET | IR1, 5 gsm | 5 gsm | no |
| Exp. 2 | PET | IR2, 5 gsm | 5 gsm | No |
| Exp. 3 | PET | IR3, 5 gsm | 5 gsm | No |
| Exp. 4 | PET | IR4, 5 gsm | 5 gsm | No |
| Exp. 5 | PET | IR2, 5 gsm | 5 gsm | 6 gsm |
| Commercial | PET | NA | NA | NA |
| Backlit Display | | | | |

PET is Polyethylene terephthalate

TABLE 4

| | Image | Coin | Taber | Light |
|---|---|---|---|---|
| Sample ID | quality | scratch test | abrasion | block effect |
| Exp. 1 | 5 | 3+ | 4 | NA |
| Exp. 2 | 5 | 5 | 5 | NA |
| Exp. 3 | 4+ | 5 | 5 | NA |
| Exp. 4 | 4 | 2 | 3 | NA |
| Exp. 5 | 5 | 5 | 5 | 100% opaque |
| Commercial | 5 | 2 | 4 | NA |
| Backlit Display | | | | |

While the present technology has been described with reference to certain examples, those skilled in the art will appreciate that various modifications, changes, omissions, and substitutions can be made without departing from the spirit of the disclosure. It is intended, therefore, that the disclosure be limited only by the scope of the following claims.

What is claimed is:

1. A printable film, comprising:
a transparent polymeric film substrate;
an image receiving layer on a front surface of the transparent polymeric film substrate, wherein the image receiving layer comprises polymerized vinyl chloride monomer blended with or copolymerized with a second polymerized monomer; and
a light diffusing layer on a back surface of the transparent polymeric film substrate, wherein the light diffusing layer comprises:
particles of a first inorganic material,
particles of a second inorganic material, and
a binder.

2. The printable film of claim 1, wherein the second polymerized monomer is from a vinyl monomer, a vinyl ester monomer, a vinyl alcohol monomer, or an acid and anhydride based monomer.

3. The printable film of claim 1, wherein the polymerized vinyl chloride monomer is copolymerized with the second polymerized monomer.

4. The printable film of claim 1, wherein the polymerized vinyl chloride monomer and the second polymerized monomer are polymerized individually as homopolymers that are blended together.

5. The printable film of claim 1, wherein the polymerized vinyl chloride monomer is present in an amount of 15 wt % to 90 wt % by total weight of the image receiving layer.

6. The printable film of claim 1, wherein the first inorganic material has a refractive index greater than 1.8 and wherein a difference between the refractive index of the first inorganic material and a refractive index of the second inorganic material is from 0.4 to 1.8.

7. The printable film of claim 1, wherein the particles of the first inorganic material have a D50 particle size of 400 nm to 700 nm and the particles of the second inorganic material have a D50 particle size that is 1.5 to 3 times the size of the particles of the first inorganic material.

8. The printable film of claim 1, wherein the first inorganic material is TiO₂ and the second inorganic material is calcium carbonate, zeolite, silica, talc, alumina, aluminum trihydrate, calcium silicate, kaolin, calcined clay, or combinations thereof.

9. The printable film of claim 1, further comprising a light blocking layer applied to the light diffusing layer opposite the transparent polymeric film substrate.

10. A method of making a printable film, comprising:
applying an image receiving layer to a front surface of a transparent polymeric film substrate, wherein the image receiving layer comprises polymerized vinyl chloride monomer blended with or copolymerized with a second polymerized monomer; and
applying a light diffusing layer to a back surface of the transparent polymeric film substrate, wherein the light diffusing layer comprises:
particles of a first inorganic material,
particles of a second inorganic material, and
a binder.

11. The method of claim 10, further comprising applying a corona treatment to the transparent polymeric film substrate before applying one or both of the image receiving layer or the light diffusing layer.

12. The method of claim 10, further comprising applying a tie layer to the transparent polymeric film substrate before applying one or both of the image receiving layer or the light diffusing layer, wherein the tie layer comprises an emulsion of acrylic polymer or acrylic copolymer having a thickness of 0.1 micrometer to 3 micrometer.

13. A system, comprising:
a printable film comprising:
a transparent polymeric film substrate;
an image receiving layer on a front surface of the transparent polymeric film substrate, wherein the image receiving layer comprises polymerized vinyl chloride monomer blended with or copolymerized with a second polymerized monomer; and
a light diffusing layer on a back surface of the transparent polymeric film substrate, wherein the light diffusing layer comprises particles of a first inorganic material, particles of a second inorganic material, and a binder; and
an inkjet ink to print onto the printable film, the inkjet ink comprising:
a liquid vehicle,
latex particles, and
colorant.

14. The system of claim 13, wherein the latex particles have an average particle size of 20 nm to 500 nm.

15. The system of claim 13, wherein the second polymerized monomer is a vinyl monomer, a vinyl ester monomer, a vinyl alcohol monomer, or an acid and anhydride based monomer, and wherein the polymerized vinyl chloride monomer and the second polymerized monomer are polymerized together as a copolymer.
